(19) United States
(12) Patent Application Publication
(10) Pub. No.: US 2026/0347648 A1
(43) Pub. Date: Nov. 5, 2026

(54) NON-SOLVENT POLYURETHANE SYSTEM AND LAMINATE

(71) Applicant: BASF SE, Ludwigshafen Am Rhein (DE)

(72) Inventors: Jian Feng XU, Shanghai (CN); Zu Bao NIE, Shanghai (CN); Hang Yu XU, Shanghai (CN)

(73) Assignee: BASF SE, Ludwigshafen Am Rhein (DE)

(21) Appl. No.: 19/123,811

(22) PCT Filed: Oct. 20, 2023
(86) PCT No.: PCT/EP2023/079237

§ 371 Date: Apr. 24, 2025

(30) Foreign Application Priority Data
Oct. 25, 2022 (WO) PCT/CN2022/127336

(51) Int. Cl. C09D 175/08; B32B 5/26; B32B 7/12; C08G 18/10; C08G 18/32; C08G 18/48; C08G 18/66; D06N 3/00; D06N 3/14

(52) U.S. Cl. CPC C09D 175/08; B32B 5/26; B32B 7/12; C08G 18/10; C08G 18/3206; C08G 18/4854; C08G 18/6674; D06N 3/0088; D06N 3/146; D06N 3/147; B32B 2262/0276

(57) ABSTRACT

The present invention relates to a non-solvent polyurethane system, comprising (a) a polyol component; (b) an isocyanate component, wherein the polyol component (a) comprises 15 wt % to 50 wt % of at least one polyol (a-1) having a weight average molecular weight in the range of from 500 g/mol to 2000 g/mol and 50 wt % to 85 wt % of at least one polyol (a-2) having a weight average molecular weight in the range of from 2500 g/mol to 5000 g/mol, each based on the total weight of the polyol component (a); wherein the isocyanate component (b) has a functionality of from 2.05 to 2.15 and an NCO % in the range from 16 wt % to 20 wt %; and wherein the non-solvent polyurethane system has an isocyanate index in the range from 95 to 120. Also provided are a non-solvent PU synthetic leather, a non-solvent PU synthetic leather laminate and use thereof.

### FIELD OF THE PRESENT INVENTION

The present invention relates to a non-solvent polyurethane system comprising a polyol component and an isocyanate component, and a laminate comprising the same.

### BACKGROUND OF THE PRESENT INVENTION

Non-solvent polyurethane (PU) synthetic leather is one of eco-friendly solutions for synthetic leather industry, which generally comprises a top coat layer, a base coat layer of non-solvent PU materials and a substrate layer. However, since non-solvent PU materials have low thermal forming performance and wrinkle resistance performance, shaped non-solvent PU synthetic leather always tends to have a shape deformation afterward, and always easily shows wrinkles after the thermal forming/setting process for the layered non-solvent PU synthetic leather.

CN112195662A discloses a water-based non-solvent polyurethane synthetic leather for women's shoes and luggage, the polyurethane synthetic leather comprises a base fabric layer, a non-solvent foam layer, an aqueous middle layer and an aqueous top layer. However, CN112195662A does not involve the thermal forming performance and wrinkle resistance performance of the water-based non-solvent polyurethane synthetic leather.

CN108824017A discloses an environmentally friendly water-based solvent-free leather for shoes, comprising a water-based PU layer, a non-solvent layer and a fabric layer. However, CN108824017A does not involve the thermal forming performance and wrinkle resistance performance of the water-based non-solvent leather.

In some applications, such as boots and saddles, the used PU synthetic leather should have good shaping keeping performance and good wrinkle resistance and can maintain some other conventional properties. However, until now, there is no non-solvent PU synthetic leather or laminate which shows good shaping keeping performance and good wrinkle resistance, and at the same time maintains some other conventional properties.

Thus, there is a need to provide a non-solvent PU synthetic leather laminate which shows good shaping keeping performance and good wrinkle resistance, and at the same time maintains some other conventional properties.

### SUMMARY OF THE PRESENT INVENTION

The object of the present invention is to provide a non-solvent PU synthetic leather laminate which shows good shaping keeping performance and good wrinkle resistance, and at the same time maintains some other conventional properties.

Accordingly, the present invention provides a non-solvent polyurethane system, comprising
(a) a polyol component,
(b) an isocyanate component,
wherein the polyol component (a) comprises 15 wt % to 50 wt % of at least one polyol (a-1) having a weight average molecular weight in the range of from 500 g/mol to 2000 g/mol and 50 wt % to 85 wt % of at least one polyol (a-2) having a weight average molecular weight in the range of from 2500 g/mol to 5000 g/mol, each based on the total weight of the polyol component (a);
wherein the isocyanate component (b) has a functionality (NCO) of from 2.05 to 2.15 and an NCO % in the range from 16 wt % to 20 wt %, and
wherein the non-solvent polyurethane system has an isocyanate index in the range from 95 to 120.

The present invention also provides a non-solvent PU synthetic leather, comprising
(1) a top coat layer;
(2) a base coat layer beneath the top coat layer; and
(3) a substrate layer,
wherein the base coat layer is made of the non-solvent polyurethane system.

The present invention further provides a non-solvent PU synthetic leather laminate, comprising
(1) a non-solvent PU synthetic leather above; and
(2) a shaping layer,
wherein the shaping layer is on the substrate layer of the non-solvent PU synthetic leather.

It has been found that the non-solvent PU synthetic leather laminate of the present invention shows good shaping keeping performance and good wrinkle resistance, and at the same time maintains some other conventional properties, such as curing property, peeling strength, and/or folding endurance.

### DETAILED DESCRIPTION OF THE PRESENT INVENTION

The present invention will be described in detail hereinafter. It is to be understood that the present invention can be embodied in many different ways and shall not be construed as limited to the embodiments set forth herein.

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article or component.

As used herein, the terms “comprise”, “comprising”, etc. are used interchangeably with “contain”, “containing”, etc. and are to be interpreted in a non-limiting, open manner. That is, e.g., further components or elements can be present. The expressions “consists of” or “consists essentially of” or cognates can be embraced within “comprises” or cognates.

Unless otherwise identified, all percentages (%) are “percent by weight”.

Unless otherwise identified, the term “total solid weight” refers to the total weight of the system or the dispersion minus the weight of all the solvents (including water).

Unless otherwise identified, for top coat layer, all the weight percentages (%) of the additives and/or auxiliaries refer to percentages of “the solid weight of the additives and/or auxiliaries divided by the total solid weight of the aqueous polyurethane dispersion”.

Unless otherwise identified, for base coat layer, all the weight percentages (%) of the additives and/or auxiliaries refer to percentages of “the solid weight of the additives and/or auxiliaries divided by the total solid weight of the non-solvent polyurethane system”.

Unless otherwise identified, the molecular weight of each component or polymer means a weight average molecular weight.

In the present invention, the molecular weights of each component were determined using gel permeation chromatography (GPC) according to GB/T 21863-2008.

In the present invention, the OH values of each polyol components were determined according to DIN 53240.

In the present invention, the functionality (Fn) of a polyol means number of terminal hydroxyl groups per polyol molecule. The functionality is determined by the following formula:

Fn=Mₙ*(OHv)/56100
wherein Mₙ represents number-average molecular weight of the polyol and OHv represents OH value of the polyol.

In the present invention, the functionality (NCO) of an isocyanate is determined by the following formula:

Functionality(NCO)=(mol-1*Fn-1+mol-2*Fn-2+ . . . +mol-n*Fn-n)/(mol-1+mol-2+ . . . +mol-n)
wherein mol-1 represents molar number of a first isocyanate and Fn-1 represents functionality (NCO) of a first isocyanate, mol-2 represents molar number of a second isocyanate and Fn-2 represents functionality (NCO) of a second isocyanate, and mol-n represents molar number of a n-th isocyanate and Fn-n represents functionality (NCO) of a n-th isocyanate.

In the present invention, the isocyanate index of the non-solvent polyurethane system is defined as the ratio of the total number of isocyanate groups of the isocyanate components which are used in the reaction to the total number of isocyanate-reactive groups, i.e., the number of active hydrogens in the compound having at least two isocyanate-reactive hydrogen-containing groups and the chain extenders. An isocyanate index of 100 means that there is one active hydrogen atom, i.e., an isocyanate-reactive function of the compound having at least two isocyanate-reactive hydrogen-containing groups and the chain extenders per isocyanate group of the isocyanate components. Isocyanate indices above 100 mean that there are more isocyanate groups than there are isocyanate-reactive groups, for example hydroxyl groups.

### Polyol Component (a)

In the present invention, the polyol component (a) comprises at least one polyol (a-1) having a weight average molecular weight in the range of from 500 g/mol to 2000 g/mol.

The polyol component (a) comprises 15 wt % to 50 wt %, preferably 25 wt % to 40 wt % of the polyol (a-1) above, such as 20 wt %, 25 wt %, 30 wt %, 35 wt %, 40 wt %, 45 wt %, etc., based on the total weight of the polyol component (a).

The polyol useful as polyol (a-1) preferably has a weight average molecular weight in the range of from 600 g/mol to 1500 g/mol, preferably from 800 g/mol to 1200 g/mol, more preferably from 1000 g/mol to 1100 g/mol, such as 700 g/mol, 800 g/mol, 900 g/mol, 1000 g/mol, 1100 g/mol, 1200 g/mol, 1300 g/mol, and 1400 g/mol, etc.

The polyol useful as polyol (a-1) preferably has a OH value in the range of from 60 to 200 mgKOH/g, preferably in the range of from 90 to 130 mgKOH/g, more preferably in the range of from 100 to 120 mgKOH/g, such as 70 mgKOH/g, 80 mgKOH/g, 90 mgKOH/g, 100 mgKOH/g, 110 mgKOH/g, 120 mgKOH/g, 130 mgKOH/g, 140 mgKOH/g, 150 mgKOH/g, 160 mgKOH/g, 170 mgKOH/g, 180 mgKOH/g, 190 mgKOH/g, etc.

The polyol useful as polyol (a-1) is selected from polyol having a functionality (Fn) in the range of from 1.9 to 2.1, preferably a functionality in the range of from 1.95 to 2.05, more preferably a functionality of 2.

The polyol useful as polyol (a-1) is selected from polyether polyol derived from oxygen-containing heterocyclic compounds comprising 3 to 6 carbon atoms, such as 3, 4, 5 or 6 carbon atoms, preferably tetrahydrofuran. Preferably, the polyol is produced by polymerizing tetrahydrofuran as repeating unit, preferably capped with primary hydroxyl. More preferably, the polyol is polytetrahydrofuran, which can be produced by polymerizing tetrahydrofuran as repeating unit, and capped with primary hydroxyl. In one preferred embodiment, the polytetrahydrofuran has a functionality of 2, a weight average molecular weight (g/mol) of 975 to 1025, and OH value (OHv) of 109.5 to 115.1 mgKOH/g, such as PTHF1000 from BASF.

The polyol useful as polyol (a-1) in the present invention can be produced by known processes or can be commercially available.

In the present invention, the polyol component (a) further comprises at least one polyol (a-2) having a weight average molecular weight in the range of from 2500 g/mol to 5000 g/mol.

The polyol component (a) comprises 50 wt % to 85 wt %, preferably 60 wt % to 75 wt %, more preferably 65 wt % to 70 wt % of the polyol (a-2) above, such as 55 wt %, 60 wt %, 65 wt %, 70 wt %, 75 wt %, 80 wt %, etc., based on the total weight of the polyol component (a).

The polyol useful as polyol (a-2) preferably has a weight average molecular weight in the range of from 3000 g/mol to 4000 g/mol, preferably from 3200 g/mol to 3600 g/mol, such as 3100 g/mol, 3200 g/mol, 3300 g/mol, 3400 g/mol, 3500 g/mol, 3600 g/mol, 3700 g/mol, 3800 g/mol, and 3900 g/mol, etc.

The polyol useful as polyol (a-2) preferably has a OH value in the range of from 10 to 50 mgKOH/g, preferably in the range of from 20 to 40 mgKOH/g, such as 15 mgKOH/g, 25 mgKOH/g, 30 mgKOH/g, 35 mgKOH/g, 45 mgKOH/g, etc.

The polyol useful as polyol (a-2) is selected from polyol having a functionality (Fn) in the range of from 1.5 to 2.5, preferably a functionality in the range of from 1.5 to 2.2, more preferably a functionality in the range of from 1.8 to 2.1, still more preferably 2.

The polyol (a-2) can be a single polyol or a mixture of two or more polyols, preferably polyether polyol, more preferably polyether polyol based on epoxide, such as ethylene oxide (EO), propylene oxide (PO), and/or butane oxide (BO). These polyether polyols can be polyether polyol produced by polymerizing epoxides, such as ethylene oxide and/or propylene oxide, as repeating unit and using propylene glycol as starter, preferably capped by ethylene oxide with primary hydroxyl group.

The polyol useful as polyol (a-2) in the present invention can be produced by known processes or can be commercially available.

Preferably, the polyol (a-2) is a poly(ethylene oxide), which can be produced by polymerizing ethylene oxide as repeating unit and using propylene glycol as starter, and capped by ethylene oxide with primary hydroxyl groups. In one preferred embodiment, the poly(ethylene oxide) has a functionality of 1.76, a weight average molecular weight (g/mol) of 3350 to 3500, and OH value (OHv) of 27 to 32 mgKOH/g, such as L2043 from BASF.

In the present invention, the polyol component (a) comprises water in an amount of 0.5 wt % or less, preferably 0.3 wt % or less, even free of water, based on the weight of the polyol component (a).

At least one of polyol (a-1) and polyol (a-2) has a linear structure. Preferably, both polyol (a-1) and polyol (a-2) have a linear structure.

The amount of polyol component (a) is preferably from 20 wt % to 50 wt %, such as 25 wt %, 30 wt %, 35 wt %, 40 wt %, 45 wt %, etc., based on the total weight of the non-solvent polyurethane system.

### Isocyanate Component (b)

Preferably, the isocyanate component (b) is in a modified state, for example through incorporation of uretidione, carbamate, isocyanurate or allophanate groups.

Preferably, the isocyanate component (b) is in the form of polyisocyanate prepolymers, which can be prepared in a conventional manner by reacting polyisocyanates with compounds having isocyanate-reactive hydrogen atoms (such as polyols) to form the polyisocyanate prepolymer. The reaction can for example be carried out at temperatures of about 80 °C, which are commonly known and described for example in “Kunststoffhandbuch Polyurethane” Günter Oertel, Carl-Hanser-Verlag, 2^{nd} edition 1983, chapter 3.1.1.

In one preferred embodiment, the isocyanate component (b) comprises or consists of a prepolymer derived from at least one isocyanate (b-1) and at least one polyol (b-2).

Isocyanate useful as isocyanate (b-1) for producing the prepolymer can comprise all isocyanates known for producing polyurethanes. These isocyanates comprise aliphatic, cycloaliphatic, araliphatic and/or aromatic isocyanates, such as tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), polymeric MDI, naphthylene 1,5-diisocyanate (NDI), tolylene 2,4- and/or 2,6-diisocyanate (TDI), 3,3′-dimethyl diphenyl diisocyanate, 1,2-diphenylethane diisocyanate and/or phenylene diisocyanate, or a mixture thereof.

Preferably, isocyanate useful as isocyanate (b-1) comprises diphenylmethane 4,4′-diisocyanate.

Preferably, the amount of isocyanate (b-1) is in the range of from 50 wt % to 75 wt %, preferably 60 wt % to 70 wt %, such as 55 wt %, 65 wt %, etc., based on the total weight of the isocyanate component (b).

In the present invention, the polyol (b-2) comprises at least one polyol (b-2-1) having a weight average molecular weight in the range of from 1000 g/mol to 3000 g/mol, preferably 1500 g/mol to 2500 g/mol, such as 2000 g/mol.

Preferably, the amount of polyol (b-2-1) is in the range of from 10 wt % to 30 wt %, preferably 15 wt % to 25 wt %, such as 20 wt %, based on the total weight of the isocyanate component (b).

The polyol useful as polyol (b-2-1) preferably has a OH value in the range of from 20 to 100 mgKOH/g, preferably in the range of from 40 to 80 mgKOH/g, more preferably in the range of from 50 to 70 mgKOH/g, such as 30 mgKOH/g, 40 mgKOH/g, 50 mgKOH/g, 60 mgKOH/g, 70 mgKOH/g, 80 mgKOH/g, 90 mgKOH/g, etc.

The polyol useful as polyol (b-2-1) is selected from polyol having a functionality (Fn) in the range of from 1.9 to 2.1, preferably a functionality in the range of from 1.95 to 2.05, more preferably a functionality of 2.

The polyol useful as polyol (b-2-1) is selected from polyether polyol derived from oxygen-containing heterocyclic compounds comprising 3 to 6 carbon atoms, such as 3, 4, 5 or 6 carbon atoms, preferably tetrahydrofuran. Preferably, the polyol (b-2-1) is produced by polymerizing tetrahydrofuran as repeating unit, preferably capped with primary hydroxyl. Preferably, the polyol (b-2-1) is polytetrahydrofuran, which can be produced by polymerizing tetrahydrofuran as repeating unit, and capped with primary hydroxyl. In one preferred embodiment, the polyol (b-2-1) is polytetrahydrofuran, such as PTHF2000 from BASF.

The polyol useful as polyol (b-2-1) in the present invention can be produced by known processes or can be commercially available.

In the present invention, the polyol component (b-2) can further comprise at least one polyol (b-2-2) having a weight average molecular weight in the range of from 1000 g/mol to 3000 g/mol, preferably 1500 g/mol to 2500 g/mol, such as 2000 g/mol.

Preferably, the amount of polyol (b-2-2) is in the range of from 10 wt % to 40 wt %, preferably 15 wt % to 25 wt %, such as 20 wt %, 30 wt %, 35 wt %, etc., based on the total weight of the isocyanate component (b).

The polyol useful as polyol (b-2-2) preferably has a OH value in the range of from 80 to 200 mgKOH/g, preferably in the range of from 120 to 180 mgKOH/g, more preferably in the range of from 150 to 170 mgKOH/g, such as 90 mgKOH/g, 100 mgKOH/g, 110 mgKOH/g, 120 mgKOH/g, 130 mgKOH/g, 140 mgKOH/g, 150 mgKOH/g, 160 mgKOH/g, etc.

The polyol useful as polyol (b-2-2) is selected from polyol having a functionality (Fn) in the range of from 2.9 to 3.1, preferably a functionality in the range of from 2.95 to 3.05, more preferably a functionality of 3.

The polyol useful as polyol (b-2-2) can be a single polyol or a mixture of two or more polyols, preferably polyether polyol, more preferably polyether polyol based on epoxide, such as ethylene oxide (EO), propylene oxide (PO), and/or butane oxide (BO), preferably propylene oxide (PO).

The polyol useful as polyol (b-2-2) in the present invention can be produced by known processes or can be commercially available.

At least one of polyol (b-2-1) and polyol (b-2-2) has a linear structure. Preferably, both polyol (b-2-1) and polyol (b-2-2) have a linear structure.

The isocyanate component (b) has an NCO % in the range from 16 wt % to 20 wt %, preferably in the range from 17 wt % to 19 wt %, such as 18 wt %.

The isocyanate component (b) has a functionality (Fn) of from 2.05 to 2.15, preferably from 2.08 to 2.12, such as 2.09, 2.10, etc.

The amount of polyol (b-2) is in the range of from 25 wt % to 50 wt %, preferably 30 wt % to 40 wt %, such as 35 wt %, 45 wt %, etc., based on the total weight of the isocyanate component (b).

The amount of the isocyanate component (b) is preferably from 20 wt % to 50 wt %, such as 25 wt %, 30 wt %, 35 wt %, 40 wt %, 45 wt %, etc., based on the total weight of the non-solvent polyurethane system.

Chain Extender and/or Crosslinking Agent (c)

In the present invention, the non-solvent polyurethane system can comprise a chain extender and/or crosslinking agent (c).

Chain extenders and/or crosslinking agents (c) that can be used are substances having a molar mass which is preferably smaller than 500 g/mol, particularly preferably from 60 to 400 g/mol, wherein chain extenders have 2 hydrogen atoms reactive toward isocyanates and crosslinking agents have 3 hydrogen atoms reactive toward isocyanate. These chain extenders and/or crosslinking agents can be used individually or preferably in the form of a mixture. It is preferable to use diols and/or triols having molecular weights smaller than 500, particularly from 60 to 400, and in particular from 60 to 350. Examples of those that can be used are aliphatic, cycloaliphatic, and/or araliphatic diols having from 2 to 14, preferably from 2 to 10 carbon atoms, e.g., ethylene glycol, 1,3-propanediol, 1,4-butanediol (BDO), 1,6-hexanediol, 1,10-decanediol, 1,2-, 1,3-, and 1,4-dihydroxycyclohexane, diethylene glycol, dipropylene glycol, tripropylene glycol, diethanolamine, or triols, e.g., 1,2,4- or 1,3,5-trihydroxycyclohexane, glycerol, and trimethylolpropane. Preference is given to using ethylene glycol, 1,3-propanediol, or 1,4-butanediol, especially 1,4-butanediol.

The amount of chain extender and/or crosslinking agent (c) is preferably from 0.5 to 5 wt %, more preferably from 1.5 to 4.5 wt %, based on the total weight of polyol component (a).

### Catalyst (d)

In the present invention, the non-solvent polyurethane system can comprise a catalyst (d).

As the catalyst (d), it is possible to use all compounds which can accelerate the reaction between isocyanates and polyols. Such compounds are known and are described, for example, in “Kunststoffhandbuch, volume 7, Polyurethane”, Carl Hanser Verlag, 3rd edition 1993, chapter 3.4.1. These catalysts comprise amine-based catalysts and catalysts based on organic metal compounds, or the mixture of thereof.

As amine-based catalysts, it is possible to use, for example, strongly basic amines such as N, N, N-triethylaminoethoxyethanol, bis(N,N-dimethylaminoethyl) ether, dimethyl cyclohexylamine, trimethyl hydroxyethyl ethylenediamine, dimethylbenzylamine, triethylamine, triethylenediamine, pentamethyldipropylenetriamine, dimethylethanolamine, N-methylimidazole, N-ethylimidazole, tetramethylhexamethylenediamine, tris(dimethylaminopropyl) hexahydrotriazine, dimethylaminopropylamine, N-ethylmorpholine, diazabicycloundecene, diazabicyclononene. diazabicyclooctane, preferably triethylenediamine or bis(N,N-dimethylaminoethyl) ether.

As catalysts based on organic metal compounds, it is possible to use, for example, organic tin compounds such as tin (II) salts of organic carboxylic acids, e.g., tin (II) acetate, tin (II) octoate, tin (II) ethylhexanoate and tin (II) laurate, and the dialkyltin (IV) salts of organic carboxylic acids, e.g., dibutyltin diacetate, dibutyltin dilaurate, dibutyltin maleate and dioctyltin diacetate, and also Zn salts or Bi salts, e.g., zinc octoate, bismuth (III) neodecanoate, bismuth 2-ethylhexanoate and bismuth octanoate, or alkali metal salts of carboxylic acids, e.g., potassium acetate or potassium formate.

The catalyst (d) used in the invention can be commercially available, such as Additive CX 93600 and Haptex CC 6945/92 C-CC from BASF.

Typically, the amount of the catalyst (d) is preferably from 0.05 to 5 wt %, more preferably from 0.1 to 1.5 wt %, based on the total weight of polyol component (a).

### Filler (e)

In the present invention, the non-solvent polyurethane system can comprise a filler (e).

According to the present invention, filler that can be used, if present, is inorganic filler, which is selected from calcium carbonate (CaCO₃), kaolin, montmorillonite, aluminum hydroxide, barium sulfate, or talc, preferably calcium carbonate, kaolin, or montmorillonite, more preferably calcium carbonate.

The amount of filler is from 30 to 55 wt %, preferably from 40 to 50 wt %, based on the total weight of the polyol component (a) and the isocyanate component (b), such as 35 wt %, 45 wt %, etc.

Additives and/or Auxiliaries (f)

In the present invention, the non-solvent polyurethane system can comprise additives and/or auxiliaries (f).

Additives and/or auxiliaries (f) that can be used comprise surfactants, preservatives, pigment, colorants, antioxidants, silicone oil leveling agent, stabilizers, thickener, blowing agent, wetting agent and reinforcing agents. In preparing the non-solvent polyurethane system, it is preferred to employ one of above additives and/or auxiliaries, or the mixture thereof.

Typically, the amounts of additives and/or auxiliaries, are preferably from 0 to 12 wt %, more preferably from 0.1 to 10 wt %, based on the total weight of the non-solvent polyurethane system.

According to the present invention, thickener, wetting agent, and antioxidant are preferably used. Those materials that can be used, if present, include all thickener, wetting agent, and antioxidant commonly used in the non-solvent polyurethane system. The amount of each of them is preferably from 0.1 to 5 wt %, more preferably from 0.5 to 1 wt %, each based on the total weight of the non-solvent polyurethane system.

Further information concerning the mode of use and of action of the abovementioned auxiliaries and additives, and also further examples, are given by way of example in “Kunststoffhandbuch, Band 7, Polyurethane” [“Plastics handbook, volume 7, Polyurethanes”], Carl Hanser Verlag, 3rd edition 1993, chapter 3.4.

According to the present invention, the non-solvent polyurethane system has an isocyanate index in the range from 95 to 120, preferably in the range from 100 to 110, such as 105, 115, etc.

In the present invention, the non-solvent polyurethane system is essentially free or free of solvent, particularly free of organic solvents.

In one preferred embodiment according to the present invention, the non-solvent polyurethane system comprises:
(a) a polyol component;
(b) an isocyanate component,
wherein the polyol component (a) comprises 15 wt % to 50 wt % of at least one polyol (a-1) having a weight average molecular weight in the range of from 500 g/mol to 2000 g/mol and 50 wt % to 85 wt % of at least one polyol (a-2) having a weight average molecular weight in the range of from 2500 g/mol to 5000 g/mol, each based on the total weight of the polyol component (a);
wherein the isocyanate component (b) has a functionality of from 2.05 to 2.15 and an NCO % in the range from 16 wt % to 20 wt %;
wherein the non-solvent polyurethane system has an isocyanate index in the range from 95 to 120; and
wherein the non-solvent polyurethane system further comprises 30 to 55 wt % of calcium carbonate, based on the total weight of the polyol component (a) and the isocyanate component (b).

In another particular embodiment according to the present invention, the non-solvent polyurethane system comprises:
(a) a polyol component;
(b) an isocyanate component,
wherein the polyol component (a) comprises 25 wt % to 40 wt % of at least one polyol (a-1) having a weight average molecular weight in the range of from 500 g/mol to 2000 g/mol and 60 wt % to 75 wt % of at least one polyol (a-2) having a weight average molecular weight in the range of from 2500 g/mol to 5000 g/mol, each based on the total weight of the polyol component (a);
wherein the isocyanate component (b) has a functionality of from 2.05 to 2.15 and an NCO % in the range from 16 wt % to 20 wt %;
wherein the non-solvent polyurethane system has an isocyanate index in the range from 95 to 120; and
wherein the non-solvent polyurethane system further comprises 40 to 50 wt % of calcium carbonate, based on the total weight of the polyol component (a) and the isocyanate component (b).

In another particular embodiment according to the present invention, the non-solvent polyurethane system comprises:
(a) a polyol component;
(b) an isocyanate component,
wherein the polyol component (a) comprises 25 wt % to 40 wt % of at least one polyol (a-1) having a weight average molecular weight in the range of from 600 g/mol to 1500 g/mol and 60 wt % to 75 wt % of at least one polyol (a-2) having a weight average molecular weight in the range of from 3000 g/mol to 4000 g/mol, each based on the total weight of the polyol component (a);
wherein the isocyanate component (b) has a functionality of from 2.05 to 2.15 and an NCO % in the range from 16 wt % to 20 wt %;
wherein the non-solvent polyurethane system has an isocyanate index in the range from 95 to 120; and
wherein the non-solvent polyurethane system further comprises 40 to 50 wt % of calcium carbonate, based on the total weight of the polyol component (a) and the isocyanate component (b).

In another particular embodiment according to the present invention, the non-solvent polyurethane system comprises:
(a) a polyol component;
(b) an isocyanate component,
wherein the polyol component (a) comprises 25 wt % to 40 wt % of at least one polyol (a-1) having a weight average molecular weight in the range of from 600 g/mol to 1500 g/mol and 60 wt % to 75 wt % of at least one polyol (a-2) having a weight average molecular weight in the range of from 3000 g/mol to 4000 g/mol, each based on the total weight of the polyol component (a);
wherein the isocyanate component (b) has a functionality of from 2.05 to 2.15 and an NCO % in the range from 16 wt % to 20 wt %;
wherein the non-solvent polyurethane system has an isocyanate index in the range from 95 to 120;
wherein the isocyanate component (b) comprises a prepolymer derived from at least one isocyanate (b-1) and at least one polyol (b-2), and
wherein the non-solvent polyurethane system further comprises 40 to 50 wt % of calcium carbonate, based on the total weight of the polyol component (a) and the isocyanate component (b).

In another particular embodiment according to the present invention, the non-solvent polyurethane system comprises:
(a) a polyol component;
(b) an isocyanate component,
wherein the polyol component (a) comprises 25 wt % to 40 wt % of at least one polyol (a-1) having a weight average molecular weight in the range of from 600 g/mol to 1500 g/mol and 60 wt % to 75 wt % of at least one polyol (a-2) having a weight average molecular weight in the range of from 3000 g/mol to 4000 g/mol, each based on the total weight of the polyol component (a);
wherein the isocyanate component (b) has a functionality of from 2.05 to 2.15 and an NCO % in the range from 16 wt % to 20 wt %;
wherein the non-solvent polyurethane system has an isocyanate index in the range from 95 to 120;
wherein the isocyanate component (b) comprises a prepolymer derived from 60 wt % to 70 wt % of diphenylmethane 4,4′-diisocyanate and 30 wt % to 40 wt % of polyether polyols, each based on the total weight of the isocyanate component (b), and
wherein the non-solvent polyurethane system further comprises 40 to 50 wt % of calcium carbonate, based on the total weight of the polyol component (a) and the isocyanate component (b).

In another particular embodiment according to the present invention, the non-solvent polyurethane system comprises:
(a) a polyol component;
(b) an isocyanate component,
wherein the polyol component (a) comprises 25 wt % to 40 wt % of at least one polyol (a-1) having a weight average molecular weight in the range of from 600 g/mol to 1500 g/mol and 60 wt % to 75 wt % of at least one polyol (a-2) having a weight average molecular weight in the range of from 3000 g/mol to 4000 g/mol, each based on the total weight of the polyol component (a);
wherein the isocyanate component (b) has a functionality of from 2.05 to 2.15 and an NCO % in the range from 16 wt % to 20 wt %, and wherein the isocyanate component (b) comprises a prepolymer derived from 60 wt % to 70 wt % of diphenylmethane 4,4′-diisocyanate and 30 wt % to 40 wt % of polyether polyols, each based on the total weight of the isocyanate component (b);
wherein the non-solvent polyurethane system has an isocyanate index in the range from 95 to 120; and
wherein the non-solvent polyurethane system further comprises 40 to 50 wt % of calcium carbonate, based on the total weight of the polyol component (a) and the isocyanate component (b).

The present invention also provides a non-solvent PU synthetic leather, comprising
(1) a top coat layer;
(2) a base coat layer beneath the top coat layer; and
(3) a substrate layer,
wherein the base coat layer is made of the non-solvent polyurethane system.

In the context of the present invention, the top coat layer can be also called as a top coat skin layer.

In the present invention, an aqueous polyurethane dispersion is used for producing the top coat layer. The aqueous polyurethane has onset decomposing temperature in the range from 150 to 250 °C, preferably from 180 to 230 °C, measured by TGA. Suitable aqueous polyurethane dispersion used in the top coat layer disclosed in, for example PCT/CN2020/084834, the contents of which are expressly incorporated herein by reference.

In the present invention, the aqueous polyurethane dispersion used for the top coat layer can be commercially available, such as Haptex CC 6945/90 C-CH from BASF, or is prepared from an isocyanate component (a′) and a polyol component (b′). The method for preparing the aqueous polyurethane dispersion can be any method commonly used in the art and is known by those skilled in the art. The isocyanate component (a′) comprises the customary aliphatic, cycloaliphatic and aromatic di- and/or polyisocyanates. Preference is given to using tolylene diisocyanate (TDI), diphenylmethane diisocyanate (MDI) and mixtures of diphenylmethane diisocyanate and polyphenylene polymethylene polyisocyanates (polymeric MDI), and especially diphenylmethane diisocyanate (monomeric MDI). Isophorone diisocyanate (IPDI), hexamethylene diisocyanate (HDI), and hydrogenated diphenylmethane-4,4′-diisocyanate (H12MDI) are also preferable.

The isocyanates or else hereinbelow described isocyanate prepolymers may also be in a modified state, for example through incorporation of uretidione, carbamate, isocyanurate, or allophanate groups. It is further possible to use blends of the various isocyanates.

The polyisocyanates may also be employed in the form of polyisocyanate prepolymers. These prepolymers are known in the prior art. They are prepared in a conventional manner by reacting above-described polyisocyanates with hereinbelow described compounds having isocyanate-reactive hydrogen atoms to form the prepolymer. The reaction may for example be carried out at temperatures of about 80 °C. The polyol/polyisocyanate ratio is generally chosen such that the NCO content of the prepolymer is in the range from 6 wt % to 25 wt %.

The polyol component (b′) preferably comprises polyetherols and/or polyesterols. These are commonly known and described for example in “Kunststoffhandbuch Polyurethane” Günter Oertel, Carl-Hanser-Verlag, 2nd edition 1983, chapter 3.1.1. Alternative designations likewise customary in the pertinent art are polyether polyols or polyether alcohols on the one hand and polyester polyols or polyester alcohols on the other hand.

In the present application, preferably, the polyol component (b′) is a polyol mixture. The polyol component (b′) comprises (b′-1) a polyol having a weight average molecular weight in the range of from 500 g/mol to 10000 g/mol, and functionality in the range of from 2 to 4, and (b′-2) a polyol having a weight average molecular weight in the range of from 500 g/mol to 3000 g/mol, and functionality in the range of from 2 to 4. By way of example, polyol (b′-1) may be polyester, such as XCP-2000N and polyol (b′-2) may be polyether, preferably hydrophilic polyether based on polyethylene glycol, such as Ymer N120.

The polyol component (b′) also comprises (b′-3) a chain extender having a weight average molecular weight of less than 400 g/mol, and (b′-4) a hydrophilic chain extender containing carboxylate group or sulphonate group.

Chain extender (b′-3) that may be used are substances having a molar mass which is preferably smaller than 400 g/mol, particularly preferably from 60 to 400 g/mol, wherein chain extenders have at least 2 hydrogen atoms reactive toward isocyanates. These chain extenders may be used individually or preferably in the form of a mixture. It is preferable to use diols and/or triols having molecular weights from 60 to 400, and in particular from 60 to 350. Examples of those that may be used are aliphatic, cycloaliphatic, and/or aliphatic diols having from 2 to 10 carbon atoms, e.g., ethylene glycol, 1,3-propanediol, 1,4-butanediol, 1,6-hexanediol, 1,10-decanediol, 1,2-, 1,3-, and 1,4-dihydroxycyclohexane, diethylene glycol, dipropylene glycol, tripropylene glycol, diethanolamine, or triols, e.g., 1,2,4- or 1,3,5-trihydroxycyclohexane, glycerol, and trimethylolpropane. It is also preferable to use diamine and/or triamine. Examples of those that may be used are diethylenetriamine or N-(2-Hydroxyethyl)ethylenediamine. The amount of chain extender (b′-3), based on the total solid weight of the aqueous polyurethane dispersion, is preferably from 0.1 wt % to 10 wt %, particularly preferably from 0.2 wt % to 8 wt %.

Hydrophilic chain extenders (b′-4) that may be used are hydrophilic chain extenders with carboxyl group or sulphonate group. They provide hydrophilic groups for the aqueous polyurethane dispersion to ensure that the dispersion has an appropriate hydrophilicity. Preferably, AB-salt (Sodium 2-[(2-aminoethyl)amino]ethanesulphonate) or DMPA (dimethylolpropionic acid) may be used here. The amount of hydrophilic chain extenders (b′-4), based on the total solid weight of the aqueous polyurethane dispersion, is preferably from 0.1 wt % to 50 wt %, particularly preferably from 0.2 wt % to 35 wt %.

The aqueous polyurethane dispersion contains no more than 0.5%, preferably less than 0.1% of carboxylate group, based on the total solid weight of the aqueous polyurethane dispersion, wherein the carboxylate group derives from hydrophilic extenders with carboxyl group as well as other carboxyl-containing starting materials which are used to prepare the aqueous polyurethane dispersion. Additionally, the molar ratio of hydroxyl and/or amino group to the isocyanate group present in the aqueous polyurethane dispersion is 0.9 to 1.5, preferably 1.10 to 1.25.

The aqueous polyurethane dispersion optionally contains an amine neutralization agent with gel reactivity, so as to provide suitable pH range of 6 to 9 for the dispersion. The amount of amine neutralization agent, based on the total solid weight of the aqueous polyurethane dispersion, is preferably from 0.01 wt % to 5 wt %, particularly preferably from 0.05 wt % to 2 wt %. By way of example, the amine neutralization agent is selected from the group consisting of triethylenediamine (TEDA), 1,2-dimethylimidazole, N,N-dimethylcyclohexylamine, N,N,N′,N′-Tetramethylethylenediamine and tertiaryamine.

Optionally, the aqueous polyurethane dispersion contains surfactants. The surfactants may be nonionic, such as alcohol ethoxylates, alkyl polyglucosides, Bisphenol A ethoxylates, ethoxylated natural fat/oil, fatty acid ethoxylates, or/and anionic surfactants, such as fatty alcohol ethersulfates, fatty alcohol sulfates, linear alkylbenzene sulphonates, oleic acid sulphonates, di-isodecyl sulfosuccinate, alkyl ether phosphate, alkyl ether carboxylates, or/and cationic surfactants, such as amine ethoxylates, aminopolyol, quaternary ammonium surfactants.

In one preferred embodiment of the present invention, the top coat layer based on an aqueous polyurethane dispersion also contains crosslinker. Here, suitable crosslinker may be selected from aromatic- or aliphatic-polycarbodiimide (PCDI) with or without hydrophilic modification, or isocyanate. The crosslinker may be used in a mixed or single manner, preferable in a mixed manner. By way of example, Astacin Hardener CA and/or Astacin Hardener CI may be useful as the crosslinker. The amount of the crosslinker, based on the total solid weight of the aqueous polyurethane dispersion, is preferably from 0.1 wt % to 20 wt %, particularly preferably from 0.5 wt % to 15 wt %, and in particular from 1 wt % to 10 wt %.

In one preferred embodiment of the present invention, the top coat layer based on an aqueous polyurethane dispersion also contains other additives and/or auxiliaries which are commonly known by those skilled in the art. The additives and/or auxiliaries that may be used comprise surfactants, thickener, pigment, colorants, antioxidants, reinforcing agents, stabilizers and wetting agent. In preparing the aqueous polyurethane dispersion, it is generally to employ one of additives and/or auxiliaries above, or the mixture thereof, so as to improve the properties of the obtained polyurethane dispersion.

Typically, the amounts of other additives and/or auxiliaries are preferably from 0 to 25 wt %, more preferably from 0.5 wt % to 15 wt %, based on the total solid weight of the aqueous polyurethane dispersion.

As pigment, it is possible to use all compounds which are suitable for preparing polyurethane dispersion, such as Permutex PP-39-611. The amount of pigment, if present, based on the total solid weight of the aqueous polyurethane dispersion, is preferably from 1 wt % to 12 wt %, particularly preferably from 5 wt % to 10 wt %.

As thickener, it is possible to use all compounds which are commonly used for preparing polyurethane dispersion, such as Permutex RM 4456. The amount of thickener, if present, based on the total solid weight of the aqueous polyurethane dispersion, is preferably from 0.1 wt % to 8 wt %, particularly preferably from 0.5 wt % to 5 wt %.

As wetting agent, it is possible to use all compounds which are commonly used for preparing polyurethane dispersion, such as BYK 348. The amount of wetting agent, if present, based on the total solid weight of the aqueous polyurethane dispersion, is preferably from 0.1 wt % to 5 wt %, particularly preferably from 0.3 wt % to 3 wt %.

As antioxidant, it is possible to use all compounds which are suitable for preparing polyurethane dispersion. The amount of antioxidant, if present, based on the total solid weight of the aqueous polyurethane dispersion, is preferably from 0.1 wt % to 5 wt %, more preferably from 0.5 wt % to 1 wt %.

### Base Coat Layer

The base coat layer is made of the non-solvent polyurethane system according to the present invention.

The thickness of the base coat layer is in the range from 0.2 mm to 0.5 mm, preferably from 0.3 mm to 0.4 mm.

### Substrate Layer

For example, the substrate layer can comprise a leather fabric selected from cotton, viscose, polyester, elastane, microfiber and a mixture thereof in a form of woven or non-woven.

Preferably, the substrate layer has a thickness in the range from 0.5 mm to 1 mm.

Preferably, the substrate layer has an elongation in the range from 60 to 90%, such as 65%, 70%, 75%, 80%, 85%, etc.

When the substrate layer has an elongation above 90%, the wrinkle resistance of the non-solvent PU synthetic leather laminate reduces. When the substrate layer has an elongation below 60%, the shaping keeping performance of the non-solvent PU synthetic leather laminate reduces.

The present invention further provides a non-solvent PU synthetic leather laminate, comprising
(1) a non-solvent PU synthetic leather above; and
(2) a shaping layer,
wherein the shaping layer is on a substrate layer of the non-solvent PU synthetic leather.

The non-solvent PU synthetic leather laminate optionally comprises an adhesive layer between the substrate layer of the non-solvent PU synthetic leather and the shaping layer.

### Shaping Layer

For example, the shaping layer can comprise a shaping fabric selected from cotton, viscose, polyester, elastane, microfiber and a mixture thereof in a form of woven or non-woven.

Preferably, the shaping layer has a thickness in the range from 1.0 to 1.5 mm.

Preferably, the shaping layer has an elongation in the range from 20 to 40%, such as 25%, 30%, 35%, etc. When the shaping layer has an elongation above 40%, the wrinkle resistance of the non-solvent PU synthetic leather laminate reduces.

### Adhesive Layer

The adhesive layer is formed from an adhesive commonly used in the art. The adhesive can be selected from conventional adhesives, such as PVC, PU, TPU, epoxy adhesives, etc.

The present invention also relates to use of the non-solvent PU synthetic leather laminate as the upper or covering material in the application of boots, saddles, apparel, accessories, cases, electronic devices, furniture, auto upholstery, sports items or leisure products, particularly in the application of boots and saddles.

The present invention also relates to a method for producing the non-solvent PU synthetic leather laminate, especially for producing the non-solvent PU synthetic leather laminate used in the application of boots and saddles.

The method for producing the non-solvent PU synthetic leather and the non-solvent PU synthetic leather laminate can be any method commonly used in the art and is known by those skilled in the art.

In one preferred embodiment of the present invention, the method for producing the non-solvent PU synthetic leather comprises the steps of (1) applying a top coat layer on a release paper and dry; (2) applying a base coat layer on the top coat layer and dry; (3) applying a substrate layer on the base coat layer; (4) dry and pressing; and (5) stripping the release paper from the top coat layer to form the non-solvent PU leather layer.

The dry temperature is preferably in the range from 60 to 160 °C, and the dry time is preferably in the range from 1 to 20 minutes.

In one preferred embodiment of the present invention, the method for producing the non-solvent PU synthetic leather laminate comprises the steps of (1) pasting a shaping layer to the non-solvent PU leather layer by optional adhesive layer; (2) heat setting; and (3) post setting.

For example, the heat setting is carried out under a temperature in the range from 70 to 100 °C, preferably in the range from 80 to 100 °C, more preferably in the range from 85 to 90 °C, for 3 to 5 seconds.

For example, the post-setting is carried out by placing the shaped laminate at a temperature of room temperature or less for chilling and plasticizing.

In one preferred embodiment of the present invention, the post-setting is performed at a temperature of −10 °C to 0 °C, preferably −10 °C to −5 °C, for example in a freezer.

In all embodiments described herein, the sum of content of each component in the non-solvent polyurethane system is 100 wt % in total based on the total weight of the non-solvent polyurethane system.

### EMBODIMENTS

Various embodiments are listed below. It will be understood that the embodiments listed below can be combined with all aspects and other embodiments in accordance with the scope of the present invention.

Embodiment 1. A non-solvent polyurethane system, comprising
(a) a polyol component; and
(b) an isocyanate component,
wherein the polyol component (a) comprises 15 wt % to 50 wt % of at least one polyol (a-1) having a weight average molecular weight in the range of from 500 g/mol to 2000 g/mol and 50 wt % to 85 wt % of at least one polyol (a-2) having a weight average molecular weight in the range of from 2500 g/mol to 5000 g/mol, each based on the total weight of the polyol component (a);
wherein the isocyanate component (b) has a functionality of from 2.05 to 2.15 and an NCO % in the range from 16 wt % to 20 wt %; and
wherein the non-solvent polyurethane system has an isocyanate index in the range from 95 to 120.

Embodiment 2. The non-solvent polyurethane system according to embodiment 1, wherein the polyol component (a) comprises 25 wt % to 40 wt % of the polyol (a-1) and 60 wt % to 75 wt % of the polyol (a-2).

Embodiment 3. The non-solvent polyurethane system according to embodiment 1 or 2, wherein the polyol (a-1) has a weight average molecular weight in the range of from 600 g/mol to 1500 g/mol, preferably from 800 g/mol to 1200 g/mol.

Embodiment 4. The non-solvent polyurethane system according to any of the preceding embodiments, wherein the polyol (a-2) has a weight average molecular weight in the range of from 3000 g/mol to 4000 g/mol, preferably from 3200 g/mol to 3600 g/mol.

Embodiment 5. The non-solvent polyurethane system according to any of the preceding embodiments, wherein the polyol (a-1) is selected from polyether polyol derived from oxygen-containing heterocyclic compounds comprising 3 to 6 carbon atoms, preferably tetrahydrofuran.

Embodiment 6. The non-solvent polyurethane system according to any of the preceding embodiments, wherein the polyol (a-2) is selected from polyether polyol derived from epoxides, preferably ethylene oxide, propylene oxide or a mixture thereof.

Embodiment 7. The non-solvent polyurethane system according to any of the preceding embodiments, wherein the polyol (a-1) has a OH value in the range of from 60 to 200 mgKOH/g, preferably in the range of from 90 to 130 mgKOH/g.

Embodiment 8. The non-solvent polyurethane system according to any of the preceding embodiments, wherein the polyol (a-2) has a OH value in the range of from 10 to 50 mgKOH/g, preferably in the range of from 20 to 40 mgKOH/g.

Embodiment 9. The non-solvent polyurethane system according to any of the preceding embodiments, wherein the polyol (a-1) has a functionality in the range of from 1.9 to 2.1, preferably a functionality in the range of from 1.95 to 2.05, more preferably a functionality of 2.

Embodiment 10. The non-solvent polyurethane system according to any of the preceding embodiments, wherein the polyol (a-2) has a functionality in the range of from 1.5 to 2.5, preferably a functionality in the range of from 1.8 to 2.1, more preferably 2.

Embodiment 11. The non-solvent polyurethane system according to any of the preceding embodiments, wherein the isocyanate component (b) comprises a prepolymer derived from at least one isocyanate (b-1) and at least one polyol (b-2).

Embodiment 12. The non-solvent polyurethane system according to embodiment 11, wherein the amount of the isocyanate (b-1) is in the range of from 50 wt % to 75 wt %, preferably 60 wt % to 70 wt %, based on the total weight of the isocyanate component (b).

Embodiment 13. The non-solvent polyurethane system according to embodiment 11 or 12, wherein the amount of the polyol (b-2) is in the range of from 25 wt % to 50 wt %, preferably 30 wt % to 40 wt %, based on the total weight of the isocyanate component (b).

Embodiment 14. The non-solvent polyurethane system according to any of embodiments 11 to 13, wherein the isocyanate (b-1) comprises diphenylmethane 4,4′-diisocyanate.

Embodiment 15. The non-solvent polyurethane system according to any of the preceding embodiments, wherein the polyol (b-2) comprises a polyether polyol derived from oxygen-containing heterocyclic compounds comprising 3 to 6 carbon atoms, especially tetrahydrofuran.

Embodiment 16. The non-solvent polyurethane system according to embodiment 15, wherein the polyether polyol has a weight average molecular weight in the range of from 1000 g/mol to 3000 g/mol.

Embodiment 17. The non-solvent polyurethane system according to embodiment 15 or 16, wherein the polyether polyol has a OH value in the range of from 60 to 200 mgKOH/g, preferably in the range of from 90 to 130 mgKOH/g.

Embodiment 18. The non-solvent polyurethane system according to embodiment 15, wherein the polyol (b-2) comprises further polyether polyol derived from epoxides, preferably ethylene oxide, propylene oxide or a mixture thereof.

Embodiment 19. The non-solvent polyurethane system according to embodiment 18, wherein the further polyether polyol has a weight average molecular weight in the range of from 1000 g/mol to 3000 g/mol.

Embodiment 20. The non-solvent polyurethane system according to embodiment 18 or 19, wherein the further polyether polyol has a OH value in the range of from 80 to 200 mgKOH/g, preferably in the range of from 120 to 180 mgKOH/g.

Embodiment 21. The non-solvent polyurethane system according to any of the preceding embodiments, wherein the isocyanate component (b) has an NCO % in the range from 17 wt % to 19 wt %.

Embodiment 22. The non-solvent polyurethane system according to any of the preceding embodiments, wherein the isocyanate component (b) has a functionality of from 2.08 to 2.12.

Embodiment 23. The non-solvent polyurethane system according to any of the preceding embodiments, wherein the non-solvent polyurethane system has an isocyanate index in the range from 100 to 110.

Embodiment 24. The non-solvent polyurethane system according to any of the preceding embodiments, wherein the non-solvent polyurethane system further comprises a filler.

Embodiment 25. The non-solvent polyurethane system according to any of the preceding embodiments, wherein the non-solvent polyurethane system further comprises 30 to 55 wt % of a filler, preferably 40 to 50 wt %, based on the total weight of the polyol component (a) and the isocyanate component (b).

Embodiment 26. The non-solvent polyurethane system according to embodiment 24 or 25, wherein the filler comprises calcium carbonate, kaolin, montmorillonite, aluminium hydroxide, barium sulfate, or talc, preferably calcium carbonate.

Embodiment 27. A non-solvent PU synthetic leather, comprising
(1) a top coat layer;
(2) a base coat layer beneath the top coat layer; and
(3) a substrate layer,
wherein the base coat layer is made of the non-solvent polyurethane system according to any of embodiments 1 to 26.

Embodiment 28. The non-solvent PU synthetic leather according to embodiment 27, wherein the top coat layer is based on an aqueous polyurethane dispersion.

Embodiment 29. The non-solvent PU synthetic leather according to embodiment 27 or 28, wherein the top coat layer further contains a crosslinker in the range from 0.5 to 10 wt %, preferably from 0.5 to 5 wt %, based on the weight of the aqueous polyurethane dispersion.

Embodiment 30. The non-solvent PU synthetic leather according to embodiment 29, wherein the crosslinker is selected from aromatic- or aliphatic-polycarbodiimide with or without hydrophilic modification, or isocyanate trimer.

Embodiment 31. The non-solvent PU synthetic leather according to any of embodiments 27 to 30, wherein the substrate layer comprises a leather fabric selected from cotton, viscose, polyester, elastane, microfiber and a mixture thereof in a form of woven or non-woven.

Embodiment 32. The non-solvent PU synthetic leather according to any of embodiments 27 to 31, wherein the substrate layer has a thickness in the range from 0.5 to 1 mm and an elongation in the range from 60 to 90%.

Embodiment 33. A non-solvent PU synthetic leather laminate, comprising
(1) a non-solvent PU synthetic leather according to any of embodiments 27 to 32; and
(2) a shaping layer,
wherein the shaping layer is on the substrate layer of the non-solvent PU synthetic leather.

Embodiment 34. The non-solvent PU synthetic leather laminate according to embodiment 33, wherein the shaping layer comprises a shaping fabric selected from cotton, viscose, polyester, elastane, microfiber and a mixture thereof in a form of woven or non-woven.

Embodiment 35. The non-solvent PU synthetic leather laminate according to embodiment 33 or 34, wherein the shaping layer has a thickness in the range from 1.0 to 1.5 mm and an elongation in the range from 20 to 40%.

Embodiment 36. The non-solvent PU synthetic leather laminate according to any of embodiments 33 to 35, wherein the non-solvent PU synthetic leather laminate further comprises an adhesive layer between the substrate layer of the non-solvent PU synthetic leather and the shaping layer.

Embodiment 37. Use of a non-solvent PU synthetic leather laminate according to any of embodiments 33 to 36 as the upper or covering material in the application of boots, saddles, apparel, accessories, cases, electronic devices, furniture, auto upholstery, sports items or leisure products, particularly in the application of boots and saddles.

### EXAMPLES

The present invention will now be described with reference to Examples and Comparative Examples, which are not intended to limit the present invention.

The following raw materials were used:
PTHF1000 is a poly tetrahydrofuran from BASF.
PTHF2000 is a poly tetrahydrofuran from BASF.
L2043 is a polyether polyol from BASF.
Lupranate MS is diphenylmethane 4,4′-diisocyanate (MDI) from BASF.
TP1000 is a poly propylene oxide from BASF, MW=1000, Fn=3, OHv=168.
1,4-butanediol (BDO) is a chain extender.
Additive CX 93600 is a catalyst from BASF.
Haptex CC 6945/92 C-CC is a catalyst from BASF.
Haptex CC 6945/90 C-CH is a water-based polyurethane dispersion (PUD) with solid content 34.5% from BASF
Permutex PP-39-611 is Pigment Black with solid content 20.0% from Stahl.
Permutex RM 4456 is a thickener with solid content 28.0% form Stahl.
Astacin Hardener CI is a crosslinker with 70.0% solid content from BASF.
Astacin Hardener CA is a crosslinker with 60.0% solid content from BASF.
BYK 348 is a wetting agent with 100% solid content form BYK.
Favini B100 is a release paper from Favini.
KL-100 is an EVA water-based adhesive from Dongguan Keli adhesive company.

### Properties Tests

### Peeling Strength Test

Peeling strength test was carried out to the PU laminate that were just peeled from the release paper after curing, and the testing should be finished within 20 min, including specimen preparation and testing. The test follows the standard SATRA™ 411.

### Wrinkle Property

Grade 1: more than 5 wrinkles having a length of more than 6 cm;
Grade 2:3-5 wrinkles having a length of 4-6 cm;
Grade 3:3-5 wrinkles having a length of less than 4 cm;
Grade 4: less than 3 wrinkles having a length of 2-4 cm;
Grade 5: no wrinkles or less than 3 wrinkles having a length of less than 2 cm.

### Curing Property

Curing property of the base coat layer was evaluated by using nail to press the top coat of the laminate and then visually evaluating according to the following grades:
Grade 1: nail print is rebound >10 sec, or the top coat is damaged
Grade 2: nail print rebound (7 sec-9 sec);
Grade 3: nail print rebound (4 sec-6 sec);
Grade 4: nail print rebound (1 sec-3 sec);
Grade 5: no obvious nail print.

### Shaping Property

Shaping property indicates days of radian being maintained under the condition of a temperature of 70 °C and a relative humidity of 95%. The higher the days, the better the shaping keeping performance.

### Preparation of Laminates

### Inventive Example 1

### Preparation of PU Synthetic Leather Comprising a Top Coat Layer, a Base Coat Layer and a Substrate Layer

Formulations of top coating were prepared by blending the ingredients by sequence according to Table 1, and then were applied with a thickness of 100 μm within 4 hours by knife coating on a Favini B100 release paper, followed by drying in Oven #1 at 80 °C for 2 min and at 120 °C for 2 min to form a dried top coat layer. Next, the formulation of 2-component non-solvent PU system were prepared by blending the ingredients by sequence according to Table 2, and then applied with a thickness of 350 μm by knife coating on top of the dried top coat layer, and heated in Oven #2 at 80 to 140 °C for 1 to 5 min to form a base coat layer. Then, a substrate layer (polyester fabric with elongation of 75%) was applied on the dried base coat layer, and heated in Oven #3 at 120 to 140 °C for 2 to 10 min, followed by pressing. PU synthetic leather was obtained after stripping the release paper.

### Preparation of Laminates Comprising PU Synthetic Leather and a Shaping Fabric

KL-100 was applied on a shaping layer (polyester fabric with elongation of 30%) to form an adhesive layer (50 g/m²) on the shaping layer, then the PU synthetic leather was applied on the adhesive layer, and was heated in Oven at 60 to 80 °C for 10 min, to obtain a laminate comprising the PU synthetic leather and the shaping fabric.

### Comparative Examples 1 to 10

Comparative Examples 1 to 10 were produced in the same way as described in the inventive example 1 according to their corresponding formulations shown in Table 1 and Table 2.

TABLE 1
Formulations of the top coating

| Component | Weight parts |
|---|---|
| Haptex CC 6945/90 C-CH | 100 |
| Permutex PP-39-611 | 10 |
| Permutex RM 4456 | 2.5 |
| Astacin Hardener CI | 3 |
| Astacin Hardener CA | 1 |
| BYK 348 | 0.5 |

Notes:
The content of each ingredient in Table 1 is calculated by weight parts (g).

Notes: The content of each ingredient in Table 1 is calculated by weight parts (g).

TABLE 2
Formulations of the non-solvent polyurethane system and the properties of the resulted laminate

| | | Inventive | Comp. | Comp. | Comp. |
|---|---|---|---|---|---|
| | | Example 1 | Example 1 | Example 2 | Example 3 |
| Component | L2043 | 60 | 80 | 40 | 60 |
| A | PTHF1000 | 30 | 10 | 50 | 30 |
| | BDO | 6 | 6 | 6 | 6 |
| | Water | 0.3 | 0.3 | 0.3 | 0.3 |
| | Total | 96.3 | 96.3 | 96.3 | 96.3 |
| | Additive CX 93600 | 0.1 | 0.1 | 0.1 | 0.1 |
| | Haptex CC 6945/92 | 0.4 | 0.4 | 0.4 | 0.4 |
| | C-CC | | | | |
| | CaCO₃ | 50% (A + B) | 50% (A + B) | 50% (A + B) | 50% (A + B) |
| Component | Lupranate MS | 65 | 65 | 65 | 65 |
| B | | | | | |
| | TP1000 | 20 | 20 | 20 | 20 |
| | PTHF2000 | 15 | 15 | 15 | 15 |
| | NCO Content % | 18.7 | 18.7 | 18.7 | 18.7 |
| | Fn | 2.09 | 2.09 | 2.09 | 2.09 |
| | Given Index | 106 | 106 | 106 | 90 |
| Curing | | 5 | 3 | 5 | 3 |
| property | | | | | |
| Shaping | | 7 | 5 | 7 | 7 |
| property | | | | | |
| (days) | | | | | |
| Wrinkle | | 5 | 3 | 5 | 3 |
| Peeling | | 50 | 35 | 45 | 45 |
| strength | | | | | |
| (N/3 cm) | | | | | |
| Folding | | Pass | Pass | Fail | Pass |
| endurance (−15 | | | | | |
| °C, 20000 | | | | | |
| times) | | | | | |

| | | Comp. | Comp. | Comp. | Comp. | Comp. | Comp. | Comp. |
|---|---|---|---|---|---|---|---|---|
| | | Example 4 | Example 5 | Example 6 | Example 7 | Example 8 | Example 9 | Example 10 |
| Component | L2043 | 60 | 60 | 60 | 60 | 60 | 60 | 60 |
| A | PTHF1000 | 30 | 30 | 30 | 30 | 30 | 30 | 30 |
| | BDO | 6 | 6 | 6 | 6 | 6 | 6 | 6 |
| | Water | 0.3 | 0.3 | 0.3 | 0.3 | 0.3 | 0.3 | 0.3 |
| | Total | 96.3 | 96.3 | 96.3 | 96.3 | 96.3 | 96.3 | 96.3 |
| | Additive | 0.1 | 0.1 | 0.1 | 0.1 | 0.1 | 0.1 | 0.1 |
| | CX 93600 | | | | | | | |
| | Haptex | 0.4 | 0.4 | 0.4 | 0.4 | 0.4 | 0.4 | 0.4 |
| | CC | | | | | | | |
| | 6945/92 | | | | | | | |
| | C-CC | | | | | | | |
| | CaCO₃ | 50% (A + B) | 50% (A + B) | 50% (A + B) | 50% (A + B) | 50% (A + B) | 25% (A + B) | 60% (A + B) |
| Component | Lupranate | 65 | 62 | 65 | 75 | 45 | 65 | 65 |
| B | MS | | | | | | | |
| | TP1000 | 20 | 8 | 35 | 25 | 25 | 20 | 20 |
| | PTHF2000 | 15 | 30 | 0 | 0 | 20 | 15 | 15 |
| | NCO | 18.7 | 18.6 | 17.4 | 22.2 | 14.2 | 18.7 | 18.7 |
| | Content % | | | | | | | |
| | Fn | 2.09 | 2.04 | 2.18 | 2.10 | 2.09 | 2.09 | 2.09 |
| | Given | 130 | 106 | 106 | 106 | 106 | 106 | 106 |
| | Index | | | | | | | |
| Curing rate | | 5 | 3 | 5 | 5 | 4 | 5 | 5 |
| Shaping | | 3 | 4 | 6 | 7 | 4 | 5 | 7 |
| property | | | | | | | | |
| (days) | | | | | | | | |
| Wrinkle | | 5 | 4 | 5 | 3 | 4 | 4 | 5 |
| Peeling | | 35 | 50 | 50 | 35 | 50 | 60 | 40 |
| strength | | | | | | | | |
| (N/3 cm) | | | | | | | | |
| Folding | | Fail | Pass | Fail | Fail | Pass | Pass | Fail |
| endurance | | | | | | | | |
| (−15 °C, | | | | | | | | |
| 20000 | | | | | | | | |
| times) | | | | | | | | |

Notes:
The content of each ingredient in Table 2 is calculated by weight parts (g).

Notes: The content of each ingredient in Table 2 is calculated by weight parts (g).

As shown in Table 2, the inventive example 1 shows excellent performances for shaping property, wrinkle resistance, curing property, peeling strength and folding endurance, while the comparative examples show at least one of the properties above being poorer relative to the inventive example.

### Comparative Example 11

Comparative Example 11 was produced in the same way as described in the inventive example 1 except that the substrate layer is a polyester fabric with elongation of 100% and the shaping layer is a polyester fabric with elongation of 50%.

TABLE 3
The property comparison of the inventive
example 1 and the comparative example 11

| | Inventive | Comparative |
|---|---|---|
| | example 1 | example 11 |
| Shaping property (days) | 7 | 7 |
| Wrinkle | 5 | 3 |

As shown in Table 3, the comparative example 11 shows excellent shaping property but shows poorer wrinkle resistance. In contrast, the inventive example 1 shows both excellent shaping property and excellent wrinkle resistance.

It will be apparent to one of ordinary skill in the art that various modifications and variations can be made in the present invention without departing from the scope or spirit of the present invention. It is intended that the embodiments and examples be considered as exemplary only. Thus, it is intended that the present invention covers such modifications and variations as come within the scope of the appended claims and their equivalents.

1. A non-solvent polyurethane system, comprising
(a) a polyol component; and
(b) an isocyanate component,
wherein the polyol component (a) comprises 15 wt % to 50 wt % of at least one polyol (a-1) having a weight average molecular weight in the range of from 500 g/mol to 2000 g/mol and 50 wt % to 85 wt % of at least one polyol (a-2) having a weight average molecular weight in the range of from 2500 g/mol to 5000 g/mol, each based on the total weight of the polyol component (a);
wherein the isocyanate component (b) has a functionality of from 2.05 to 2.15 and an NCO % in the range from 16 wt % to 20 wt %; and
wherein the non-solvent polyurethane system has an isocyanate index in the range from 95 to 120.

2. The non-solvent polyurethane system according to claim 1, wherein;
the polyol component (a) comprises 25 wt % to 40 wt % of the polyol (a-1) and 60 wt % to 75 wt % of the polyol (a-2), or
the polyol (a-1) has a weight average molecular weight in the range of from 600 g/mol to 1500 g/mol, or
the polyol (a-2) has a weight average molecular weight in the range of from 3000 g/mol to 4000 g/mol.

3. (canceled)

4. (canceled)

5. The non-solvent polyurethane system according to claim 1, wherein the polyol (a-1) is selected from polyether polyol derived from oxygen-containing heterocyclic compounds comprising 3 to 6 carbon atoms.

6. The non-solvent polyurethane system according to claim 1, wherein the polyol (a-2) is selected from polyether polyol derived from epoxides.

7. The non-solvent polyurethane system according to claim 1, wherein:
the polyol (a-1) has a OH value in the range of from 60 to 200 mgKOH/g, or
the polyol (a-2) has a OH value in the range of from 10 to 50 mgKOH/g, preferably in the range of from 20 to 40 mgKOH/g, or
the polyol (a-1) has a functionality in the range of from 1.9 to 2.1, preferably a functionality in the range of from 1.95 to 2.05, or
the polyol (a-2) has a functionality in the range of from 1.5 to 2.5, preferably a functionality in the range of from 1.8 to 2.1.

8. (canceled)

9. (canceled)

10. (canceled)

11. The non-solvent polyurethane system according to claim 1, wherein the isocyanate component (b) comprises a prepolymer derived from at least one isocyanate (b-1) and at least one polyol (b-2).

12. The non-solvent polyurethane system according to claim 11, wherein;
the amount of the isocyanate (b-1) is in the range of from 50 wt % to 75 wt %, based on the total weight of the isocyanate component (b), or
the amount of the polyol (b-2) is in the range of from 25 wt % to 50 wt % based on the total weight of the isocyanate component (b), or
the isocyanate (b-1) comprises diphenylmethane 4,4′-diisocyanate.

13. (canceled)

14. (canceled)

15. The non-solvent polyurethane system according to claim 1, wherein the polyol (b-2) comprises a polyether polyol derived from oxygen-containing heterocyclic compounds comprising 3 to 6 carbon atoms.

16. The non-solvent polyurethane system according to claim 15, wherein:
the polyether polyol has a weight average molecular weight in the range of from 1000 g/mol to 3000 g/mol, or
the polyether polyol has a OH value in the range of from 60 to 200 mgKOH/g, or
the polyol (b-2) comprises further polyether polyol derived from epoxides.

17. (canceled)

18. (canceled)

19. The non-solvent polyurethane system according to claim 16, wherein the further polyether polyol has a weight average molecular weight in the range of from 1000 g/mol to 3000 g/mol.

20. The non-solvent polyurethane system according to claim 19, wherein the further polyether polyol has a OH value in the range of from 80 to 200 mgKOH/g, preferably in the range of from 120 to 180 mgKOH/g.

21. The non-solvent polyurethane system according to claim 1, wherein:
the isocyanate component (b) has an NCO % in the range from 17 wt % to 19 wt %, or
the isocyanate component (b) has a functionality of from 2.08 to 2.12, or
the non-solvent polyurethane system has an isocyanate index in the range from 100 to 110.

22. (canceled)

23. (canceled)

24. (canceled)

25. (canceled)

26. (canceled)

27. A non-solvent PU synthetic leather, comprising
(1) a top coat layer;
(2) a base coat layer beneath the top coat layer; and
(3) a substrate layer,
wherein the base coat layer is made of the non-solvent polyurethane system according to claim 1.

28. The non-solvent PU synthetic leather according to claim 27, wherein the top coat layer is based on an aqueous polyurethane dispersion.

29. The non-solvent PU synthetic leather according to claim 27, wherein the top coat layer further contains a crosslinker in the range from 0.5 to 10 wt %, based on the weight of the aqueous polyurethane dispersion.

30. The non-solvent PU synthetic leather according to claim 29, wherein the crosslinker is selected from aromatic- or aliphatic-polycarbodiimide with or without hydrophilic modification, or isocyanate trimer.

31. The non-solvent PU synthetic leather according to claim 27, wherein:
the substrate layer comprises a leather fabric selected from cotton, viscose, polyester, elastane, microfiber and a mixture thereof in a form of woven or non-woven, or
the substrate layer has a thickness in the range from 0.5 to 1 mm and an elongation in the range from 60 to 90%.

32. (canceled)

33. A non-solvent PU synthetic leather laminate, comprising
(1) a non-solvent PU synthetic leather according to claim 27; and
(2) a shaping layer,
wherein the shaping layer is on the substrate layer of the non-solvent PU synthetic leather.

34. The non-solvent PU synthetic leather laminate according to claim 33, wherein:
the shaping layer comprises a shaping fabric selected from cotton, viscose, polyester, elastane, microfiber and a mixture thereof in a form of woven or non-woven, or
the shaping layer has a thickness in the range from 1.0 to 1.5 mm and an elongation in the range from 20 to 40%, or
the non-solvent PU synthetic leather laminate further comprises an adhesive layer between the substrate layer of the non-solvent PU synthetic leather and the shaping layer.

35. (canceled)

36. (canceled)

37. Boots, saddles, apparel, accessories, cases, electronic devices, furniture, auto upholstery, sports items and leisure products comprising the non-solvent PU synthetic leather laminate according to claim 33 as an upper or a covering material.
